(19) United States
(12) Patent Application Publication
(10) Pub. No.: US 2016/0224731 A1
(43) Pub. Date: Aug. 4, 2016

(54) METHOD AND SYSTEM FOR AGGREGATING HEALTH RECORDS

(71) Applicant: Alexander V Kariman, Rockville, MD (US)

(72) Inventors: Alexander V Kariman, Rockville, MD (US); Andrew V Bardachenko, Obuhov (UA); Sorin Jules Lupu, Ft Myers, FL (US)

(73) Assignee: MEDEXY LLC, Rockville, MD (US)

(21) Appl. No.: 14/609,422

(22) Filed: Jan. 29, 2015

(51) Int. Cl. G06F 19/00

(52) U.S. Cl. CPC G06F 19/322

(57) ABSTRACT

The disclosed invention includes a method and a system that facilitate creation of comprehensive medical records for a plurality of patients. Further, the invention enables health care providers to access such records at the point of care and maintain their copy of such records. The solution involves network-accessible storage repositories configured to store health-related information, and capable of exchanging information with a plurality of patients and health care-related entities.

### BACKGROUND OF THE INVENTION

The present invention relates to electronic medical records and, in particular, to a system and a method that provide improved aggregation of medical information produced by plurality of health care providers. The system and method facilitate creation of comprehensive medical records, provides enhance accessibility of records at point of care, and enable patients to control their medical information.

Electronic medical records offer a number of advantages over conventional paper-based recordkeeping systems. First, the cost of generating, storing, and accessing electronic medical records is potentially lower than for comparable paper or document-based record systems. Second, the electronic medical records promise to improve the patient's access to his or her own records and thus beneficially increasing patient's involvement in the health care process.

Health care providers operating electronic medical records systems, oftentimes provide web portals to their patients, giving them access to health information. A number of organizations, both within and outside of the health care industry (such as Google and Microsoft), have taken steps toward creating health data repositories that hold electronic medical records and give patients control over them. These data repositories foresee the possibility that patients will become the custodians of their own medical records in alignment with the U.S. law that gives patients ownership of their medical information.

However, such systems are often underused. Putting responsibility on a patient for updating medical information after each doctor visit had proven to be encumbering for many patients. Inability to collect or access patient's comprehensive health record precludes doctors from having a complete view of patient's health history. Therefore, doctors cannot benefit from the information about their patients available at other points of care. Such information needs to be aggregated into a comprehensive medical record that has to be potentially accessible to all care providers. If this to be possible, patients would benefit from enhanced quality of care and other stakeholders, such as payers, would reduce their costs by avoiding duplicate procedures.

Today, electronic medical records are predominantly stored by multiple unrelated entities, none of which is specialized in providing data storage or retrieval services. For example, a health care provider may maintain an internal set of electronic records for individual patients treated by the provider. Similarly, a pharmacist may maintain records for prescriptions dispensed to a patient at a particular location or pharmacy chain. Another health care provider, however, will not normally have on-demand access to the records of either. As illustrated by even this simple example, the electronic medical records related to a patient may be spread across many entities, and each entity is limited to accessing medical records created by that particular entity.

Data sharing between health care organizations would help to address the aforementioned problem. However, providing access to a complete collection of electronic medical records from this widely distributed data has proven to be very difficult. One of the reasons is the lack of cooperation between various stakeholders and a conflict of interest. At minimum, each stakeholder would like to maintain and control its own copy of patient's medical data. Another problem is the cost of administrating and technical burden of the cooperation. For example, various health records management systems need to communicate reliably and securely, which is oftentimes difficult to achieve in real life.

A number of technologies were developed that enable medical information exchange between various stakeholders, where each stakeholder maintains its own records copy. Such technologies are typically based on some form of federated query or retrieval operation when a request is made to view electronic health records for a given patient; an example of such system is the Health Information Exchange (HIE). However, HIEs have a number of serious drawbacks. The distributed nature of this model is a significant weakness, especially considering that many health records management systems used by health care providers are not designed to respond to what amounts to on-demand requests for patient data on a 24×7×365 basis. Thus, one substantial problem with this approach is that it requires a health care provider to become a data services organization. Such systems are also expensive, unreliable and create excessive administrative burden (Health Record Banking Alliance (HRBA). [2013] A Proposed National Infrastructure for HIE Using Personally Controlled Records).

Accordingly, the need still remains for a comprehensive electronic medical records management system. The system should provide convenient access to a complete collection of patient's electronic medical records (comprehensive medical records). Further, such system should be interoperable with a diversity of medical systems of various health care organizations, it should be responsive, and should give control to patients over their health information, promoting patients' involvement in the health care process.

### SUMMARY OF THE INVENTION

One proposed solution for creating a comprehensive electronic medical records system involves creating a network-accessible storage repository configured to store electronic health-related information of individuals (health records or electronic medical records). Each individual (patient) has an electronic health records account (EHR account) in at least one network-accessible storage repository that identifies which health-related and none health-related information in the network-accessible storage repository is associated with the patient. Patients may allow health care providers or other entities participating in the health care delivery to access their information. Health care providers may deposit information into the network-accessible storage repository and associate it (link, join, connect, reference, arrange in hierarchical dependence, etc.) with a patient's EHR account.

Health care providers or other entities may deposit information to the network-accessible storage repository using an electronic interface provided by the repository; for example, using a software application that is capable of communicating with the network-accessible storage repository. This information is then saved in the network-accessible storage repository and associated with at least one EHR account, eventually forming an aggregated (comprehensive) electronic medical record of a patient.

A copy of this information, or any part of it, or the entire information associated with the patient's EHR account is then transmitted (immediately or upon a certain condition/event) over a telecommunications network (network) to any number of entities that are authorized or pre-authorized by the patient to receive such information; for example, to an electronic medical records management system accessible or controlled by a doctor “one” and to an electronic medical records management system accessible or controlled by a doctor “two”.

Therefore, each health care provider can maintain its own copy of the up-to-date patient's comprehensive electronic medical record, and this record can be readily available at the point of care via provider's electronic medical records management system or some other system.

A variety of electronic health records aggregating and messaging systems are known. Many of them facilitate patient's ownership of medical data through the use of third-party health repositories, which in some cases allow improved integration of portable medical records and engage patients in participating in their health care; others provide monetization mechanisms that help establish sustainable business model; others provide improved means for collecting and managing personal health records; and other help normalizing medical data collected from multiple sources, as well as facilitate communication of care providers amongst each other.

A number of prior art examples are known: for instance, as described in the U.S. Pat. No. 8,812,599 B2 (Publication date Aug. 19, 2014), the computer-implemented electronic messaging method and system, comprising of steps of receiving an electronic message at a first system, using the contextual information to identify an intended caregiver recipient, and facilitating delivery of the electronic message to the intended caregiver recipient. Another example is described in the U.S. application Ser. No. 11/241,704 (Publication date Apr. 5, 2007), consisting of a method, an apparatus, and an article of manufacture for controlling access to electronic health records where an individuals is provided with an electronic health records account in a network-accessible storage repository and a plurality of disposable access devices, wherein the access devices may be presented to an entity and the entity may access the individual's account. Another invention, as described in the U.S. Pat. No. 7,856,366 B2 (Publication date Dec. 21, 2010), consisting of a health record databank configured to associate electronic health records with multiple sub-accounts. Another example is described in the U.S. application Ser. No. 12/330,479 (Publication date Jun. 10, 2010), where patient's records may be maintained in health care software systems, and two health care software systems may communicate to exchange information about a patient. Another example is described in the U.S. Pat. No. 8,645,424 B2 (Publication date Feb. 4, 2014), consisting of a system for electronically recording and sharing medical data. The system comprises of an electronic source document, wherein the electronic source document comprises of a database. Another proposed invention, as described in the U.S. application Ser. No. 12/925,810 (Publication date May 5, 2011), where a clinical web server connects to at least two information technology systems and provides real time exchange of data between the existing databases. Another example is described in the U.S. application Ser. No. 11/654,024 (Publication date Feb. 21, 2008), where the interoperable health care data exchange platform links a plurality of disparate, remote applications generally representing provider systems containing electronic health records to enable the real-time collection, processing and centralized storage of health records at a data store, along with enabling controlled access to the centralized storage. Another example is described in the U.S. application Ser. No. 11/304,233 (Publication date Jun. 15, 2006), consisting of a system and method for receiving health data from a community of independent sources of health data related to one or more patients. Another example is described in the U.S. Pat. No. 8,438,041 B2 (Publication date May 7, 2013), consisting of a system and method for gathering quality data for a plurality of health care providers over an extended computer network. Another example is described in the U.S. Pat. No. 8,515,989 B2 (Publication date Aug. 20, 2013), consisting of a dynamic system and a method for locating and obtaining patient information in real-time. Another invention is described in the U.S. Pat. No. 8,788,679 B2 (Publication date Jul. 22, 2014), consisting of a method for exchanging data in health care systems between at least two servers with use of a gateway. Another example is described in the U.S. application Ser. No. 12/571,617 (Publication date Apr. 8, 2010), consisting of a multi-mode system and method for exchanging patient's medical data and medical orders between different medical information systems, pertaining to medical procedures and medical reports.

### BRIEF DESCRIPTION OF THE DRAWINGS

FIG. 1 is an example scenario that demonstrates network-accessible storage repository, as well as a plurality of patients and entities that communicate with the repository; for instance, locating EHR accounts and depositing electronic information to the network-accessible storage repository. FIG. 1 also illustrates a plurality of entities that receive information from the network-accessible storage repository.

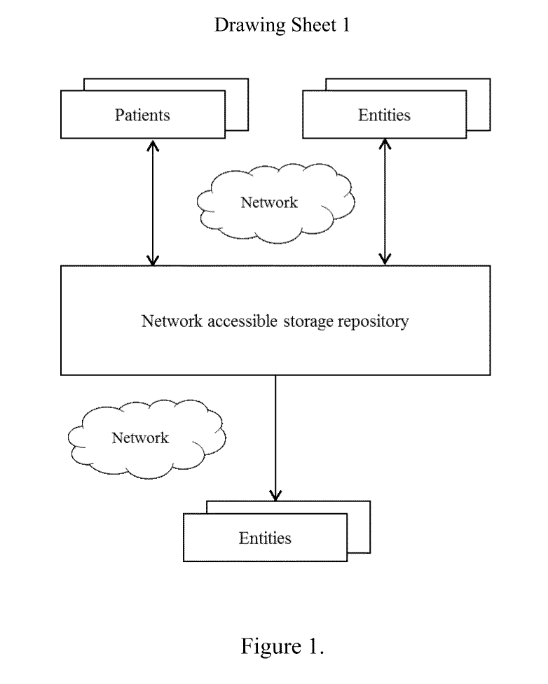

FIG. 2 is an example scenario that demonstrates certain steps of processing the electronic information deposited into the network-accessible storage repository by a patient and/or an entity.

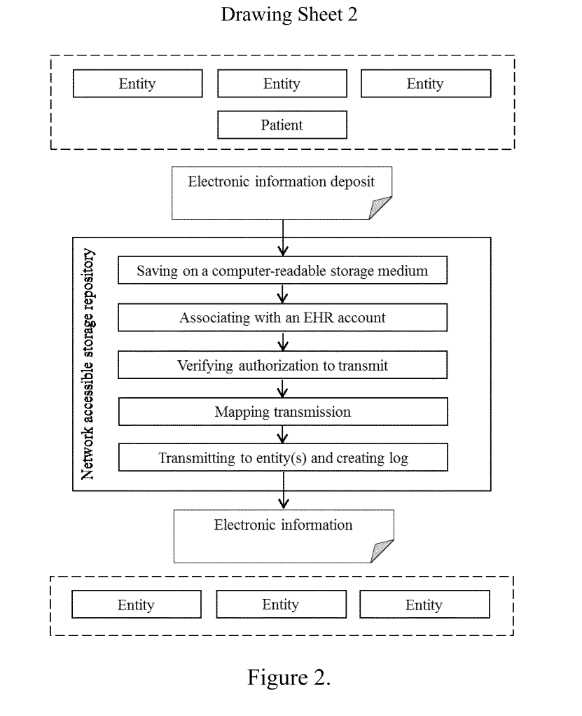

FIG. 3 is an example scenario that demonstrates one of many possible processes of forming and transmitting electronic information submitted by a plurality of entities. The process also verifies patient's authorization and transmission settings before transmitting the information to at least one of plurality of entities. Therefore, such receiving entity(s) will receive information deposited by multiple entities, which provides a more comprehensive view into the patient's health history.

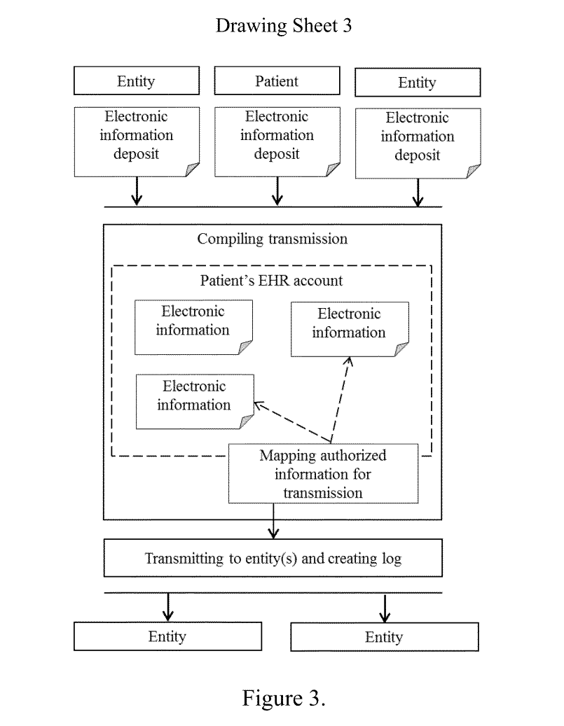

FIG. 4 is an example scenario that demonstrates an entity depositing health-related information to the network-accessible storage repository using an electronic device, and demonstrates electronic health records system, which is accessible by the entity, receiving at least some part of the deposited information.

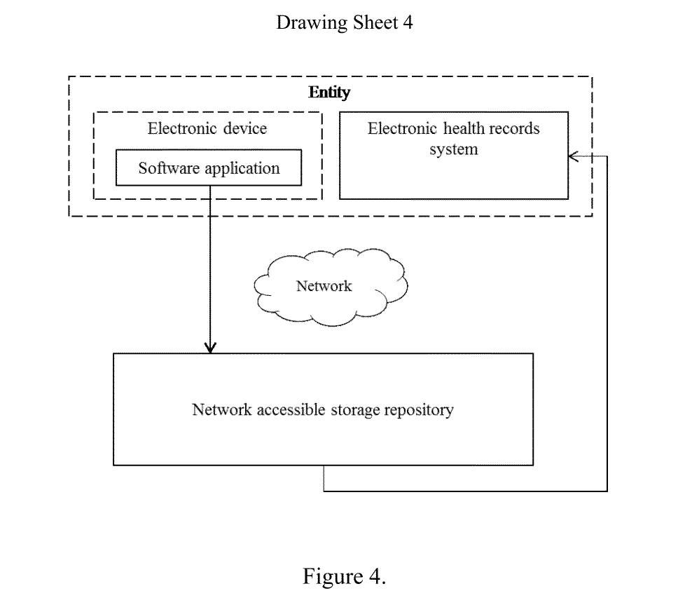

FIG. 5 is an example scenario that is described on the FIG. 4 but demonstrates additional entities receiving at least some part of the health-related information deposited by one of the entities.

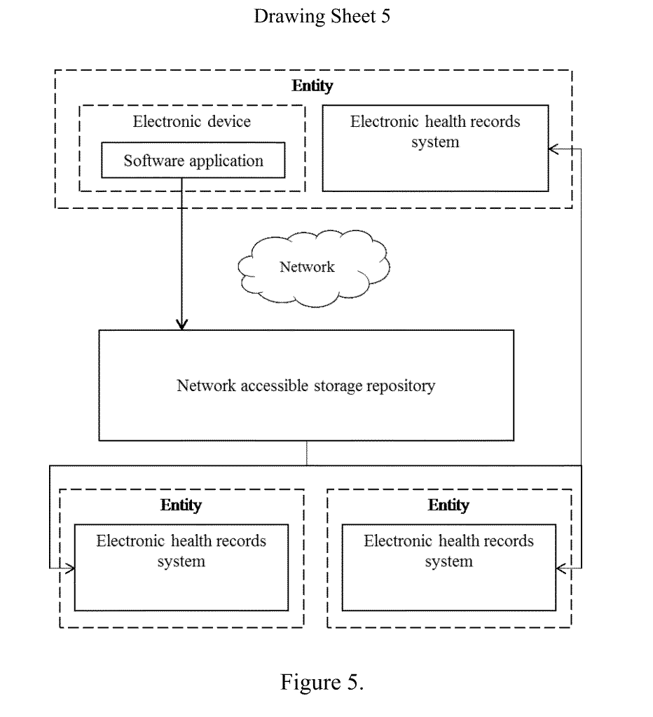

FIG. 6 is an example scenario that demonstrates a patient depositing health-related information to the network-accessible storage repository using an electronic device, and multiple entities receiving at least some health-related information deposited by the patient.

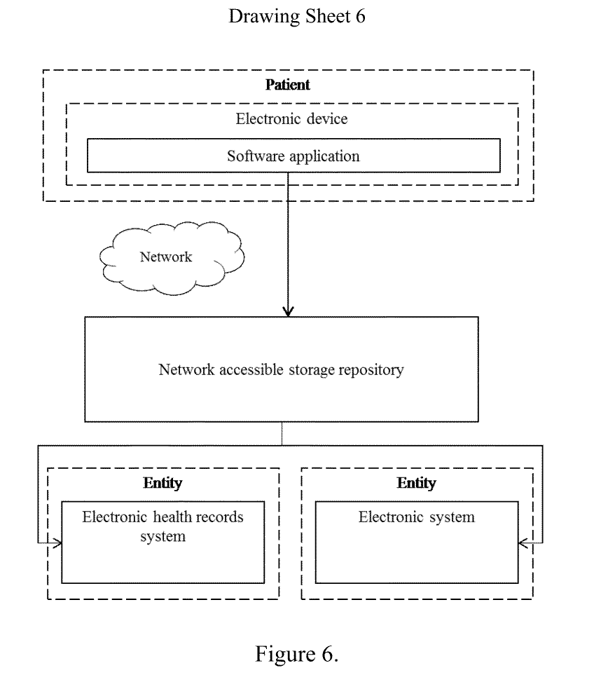

FIG. 7 is an example scenario that demonstrates a plurality of network-accessible storage repositories federated using a plurality of registries that provide federation and directory services.

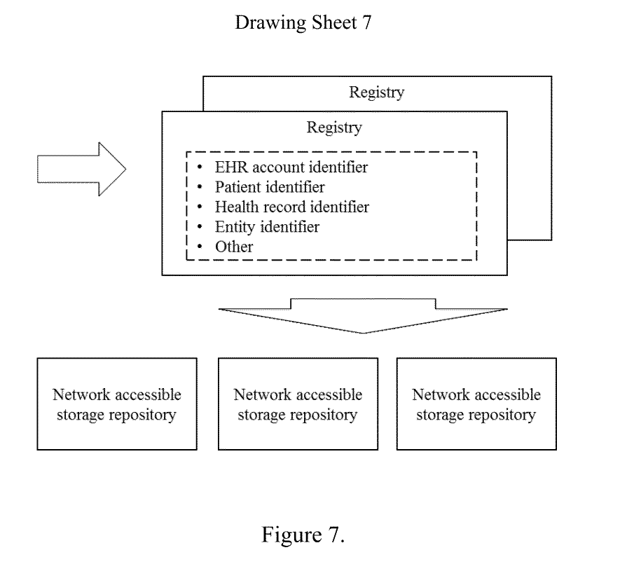

### DESCRIPTION OF EMBODIMENTS

The following embodiments of the proposed invention describe only a several of the possible implementations of the Comprehensive Electronic Health Records management system (CEHR). In one embodiment, the CEHR may be configured to provide a patient-centric computer-implemented repository for storing a plurality of electronic medical records and other information generated by a variety of sources, and a messaging system that transmits such information to a plurality of sources.

In one embodiment of the proposed invention each of the plurality of individuals (patients) have an electronic health records account (EHR account) that identifies which health-related and none health-related information in the network-accessible storage repository is associated with which patient. In another embodiment of the proposed invention, at least one individual having an EHR account may grant access to at least one other individual having an EHR account to access at least some part of his or her EHR account associated health-related and/or none health-related information; for example, when one family member grants access to another family member. In another embodiment, each of the plurality of health care providers (e.g., doctors, nurses, pharmacists, paramedics, chiropractics, radiologists, etc.), or other health care-related persons and organizations, or groups of thereof (cumulatively “entity” or “entities”), have/has an electronic account in the CEHR that allows the CEHR, at minimum, to authenticate an entity and control its access to at least some CEHR resources (CEHR account). In another embodiment, CEHR access control polices can apply to a group or a plurality of groups of entities. The entities may be grouped together, for example, to form a business unit, such as a department or an organization, or a group of organizations, or any other type of grouping.

In another embodiment, a CEHR and/or EHR account may be accessed by an entity/patient, for example, using an account instrument that consists of an account identifier (e.g., an account number, email address, patient's/entity's name, patient's social security number, etc.) and a secret (e.g., access key, password, etc.) (cumulatively “credentials”). In another embodiment such access credentials may consist or include a digital certificate and/or an authentication toking, a biometric identifier, or other means of authentication.

A variety of entities may transact with the CEHR using their respective accounts. A common transaction would be a deposit of health-related information to an individual's EHR account (deposit). Before initiating a transaction, an entity, for example a doctor, registers with the CEHR and receives a CEHR account. In one embodiment, a deposit transaction involves using a software application installed on a computing device that is capable of communicating with the CEHR over a network. In one example, a doctor authenticates with the CEHR by means of a software application interface, using his or her CEHR credentials. The said software application is installed on a portable computing device. The doctor then enters, for example, a patient's last name and the last four digits of his or her social security number, or any other acceptable identifier, including but not limited to a biometric identifier provided by the patient (for example, if the patient is uncommunicable). The application communicates this information to at least one network-accessible storage repository and signals the doctor if there is an EHR account found that matches the search criteria. If the EHR account is found, in one embodiment, doctor may access none health-related electronic information of the patient in order to confirm the patient's identity. Doctor may then deposit patient's health-related information into the CEHR, associating the information with the patient's EHR account. In another embodiment, the health-related information may be generated by the same software application, or it may be stored or accessed on/through the computing device used to communicate with the CEHR. In one embodiment, the application can be a health services application, such a medical exam data recording tool, or an electronic prescription pad, or a modality-connected application, etc. In another embodiment, such application can be a computer browser displaying at least some web-content produced by the CEHR; and in another embodiment, a native mobile device application, or a hybrid application, or a gateway application that connects electronic devices, or any other software or firmware application.

In another embodiment, if the application signals to a doctor that there is no EHR account found that matches the search criteria (as described above), the doctor may create a new EHR account for his or her patient in at least one network-accessible storage repository. In one embodiment, such account can be created using a software application (as described earlier) by inputting new patient's information into the application interface. Application then transmits this information to at least one network-accessible storage repository, and the network-accessible storage repository creates a new EHR account. Doctor can then deposit information into the account as described above.

In another embodiment of the proposed invention, for example, a doctor obtains patient's authorization before accessing the patient's health-related and/or none health-related information. Such authorization may be granted, besides other methods, via a patient's electronic consent, using, for example, an interface of software application. The information about the consent is then transmitted and recorded to/by the CEHR. In another embodiment, CEHR verifies if the patient has given consent to the doctor before authorizing doctor's access to the health-related and/or none health-related information associated with the patient's EHR account. In another embodiment, the consent may include a request from a patient to a doctor asking the doctor to provide medical records to the patient, as doctors may be obligated to do so by law. In another embodiment, the aforementioned request is automatically granted and executed by the doctor by depositing the requested patient's health records to the CEHR, and associating them with the patient's EHR account. In another embodiment, such consent may include authorization for a doctor to transmit patient's health-related and/or none health-related information out of the CEHR. In another embodiment, the consent may include authorization validity time or a limit on a number of requests, or it may specify a type of operation, such as delete, modify, view, etc. In another embodiment, such consent may be granting authorization to a specific entity or a group of entities. And in another embodiment, such consent may be granting authorization only to some part of the patient's health-related and/or none health-related information, such as laboratory results or cardio-examination data, etc. The CEHR then only allows entity's activity within the scope of the consent/authorization.

In another embodiment of the proposed invention, a patient may deposit health-related and/or none-health-related information into his or her EHR account. In one embodiment, patient may deposit information to be associated with his or her EHR account using a software application, for example, an application installed on his or her computing device (e.g., smart phone, tablet, laptop, desktop, or any other electronic device).

In one embodiment, a patient authenticates with the CEHR using his or her access credentials, for example, via a user interface of a software application installed on a computing device. The application then securely communicates with at least one network-accessible storage repository and if the patient is authorized, he or she can accesses the requested resource (e.g., health-related or none health related information, EHR account configuration settings, etc.). The patient may then deposit health-related and/or none health-related information into the CEHR, associating it with his or her EHR account or may perform other tasks. In another embodiment, the health-related and/or none health-related information may be generated by the same software application, or stored, or accessed on/through the computing device. In one embodiment, such application can be a personal electronic health records management application, lifestyle and fitness management application, disease management application, or a modality-connected application. In one embodiment, such application can be a computer browser displaying at least some web-content generated by the CEHR; and in another embodiment, a native mobile device application, or a hybrid application, or a gateway application that connects electronic devices, or any other software or firmware application.

In another embodiment, a patient may configure access parameters to the information associated with his or her EHR account for each of plurality of entities having a CEHR account, which may enable at least one of such entities to access at least some part of the health-related and/or none health-related information associated with the patient's EHR account, or make at least one configuration setting in the patient's EHR account (authorization). In another embodiment, such authorization may include a validity time or a limit on a number of times the information can be accessed or tasks performed, or specify a type of operation to be performed, such as delete, modify, view, etc. In another embodiment, such authorization may be granted to an entity or a group of entities, and/or can be transferable to another entity(s) without patient's approval. And in another embodiment, such authorization may be granting access only to some part of the patient's health-related and/or none health-related information, such as prescribed medications or physical-examination data, etc. The CEHR then only allows activity of such entity(s) within the scope of the authorization.

In another embodiment of the proposed invention, a new patient may register with at least one CEHR and create a new EHR account by providing at least some identity-related information (e.g., name, social security number, telephone number, etc.). In one embodiment, such account can be created using a software application by inputting the registration information into the application's interface. The application then transmits this information to at least one network-accessible storage repository, and the network-accessible storage repository creates a new EHR account. The patient can then deposit health-related and/or none health-related information and control access to the information, as described earlier. In another embodiment, such new EHR account can be created using an application programming interface provided by the CEHR. In another embodiment, such new EHR account can be created automatically when a new account is created in a health care provider's electronic medical records management system, or some other system. Such system then communicates with the CEHR and if such patient does not have an EHR account, it creates a new EHR account for the patient, using the application programming interfaces of the CEHR. In another embodiment, CEHR may provide the following, but not limited to, interfaces: HL7, Direct Clinical Messaging, X12, SOAP, MLLP, OAuth, LDAP, RPC, and TCP, UDP, etc.

A variety of entities may concurrently and/or subsequently transact with the CEHR. A common transaction would be depositing information to a patient's EHR account. In one implementation, once information deposit is made, CEHR saves the information on a computer-readable storage medium, and automatically associates the information with at least one EHR account. In another embodiment, this transaction is logged by the CEHR into at least one log file in a way that an audit could determine at least the time transaction. In another embodiment, an electronic event is created in the CEHR. The event may be broadcasted or consumed by any number of listeners, whether such listeners are internal or external to the CEHR, and/or connected over a network. In another embodiment, the CEHR verifies that the entity attempting a transaction is authorized to perform such transaction and if such entity is not authorized, denying such transaction and adding information about the denied transaction to the log. In another embodiment, the information transmitted to the CEHR as part of a deposit transaction is transmitted using, but not limited to the following protocols/systems: HL7, Direct Clinical Messaging, X12, SOAP, MLLP, RPC, and TCP, UDP.

Once a patient or an entity deposits information to the CEHR and associates it with at least one EHR account, in one embodiment, CEHR saves and transmits a copy of such information (or at least some part of the information) over a network to a plurality of entities. In another embodiment, once for example, a health care provider deposits information to the CEHR, specifying the individual and/or the EHR account to associate the information with, CEHR saves a copy of the information and automatically associates the information with the individual's EHR account, and automatically transmits a copy or at least some part of the information over a network to an electronic health records system accessible by the health care provider that submitted the information to the CEHR. In another embodiment, a health care provider may receive the information at some other electronic address, for example an email box, and then optionally transfer at least some part of the information into his or her electronic health records management system or some other system. In another embodiment, a health care provider may configure his or her electronic health records management system to automatically process the received information and associate it with a patient's record in the electronic health records management system or some other system.

In another embodiment, the CEHR saves a copy of the information and transmits, not only a copy of the information submitted by an entity (or some part of it), but it also transmits information (or any part of it) that is submitted by a plurality of other entities and/or a patient. Therefore, the receiving entity may obtain a more comprehensive electronic health record of the patient—a record that also includes information produced by other entities and that may contain health-related and/or none health-related information, for example, fitness or diet information generated by patient. Another implementation of the proposed invention is when each or a number of interested entities, participating in delivering the respective health-related services to the patient, receive a copy of information (health-related and/or none health-related, and whether the entire record or any specific part of it), once a new information is associated with the patient's EHR account (e.g., patient's health record is updated) and/or the old information is modified. In another embodiment, such entity(s) only receives information if a specific entity(s) has associated new information with the patient's EHR account or modified the old information. In another embodiment, such information may be transmitted to at least one entity based on schedule or another event, condition, or a set of events/conditions. In another embodiment, health care provider's electronic health records management system transmits a confirmation or an error message over a network to the CEHR once the patient's information is successfully received and/or processed, or if a transmission (and/or processing) error occurs. In another embodiment, upon the error message or no message is received after a specified timeout, the CEHR transmits the information again and/or alerts a CEHR administrator (systems administrator, operator, responsible individual, etc.). In another embodiment, the information transmitted from the CEHR to an electronic health records system, or some other system is transmitted using, but not limited to the following protocols/systems: HL7, Direct Clinical Messaging, X12, SOAP, MLLP, RPC, and TCP, UDP.

As indicated earlier, CEHR may transmit information of a plurality of patients to a plurality of entities. In one embodiment of the proposed invention, once an entity deposits patient's information to the CEHR, the CEHR saves a copy of the information but before transmitting it (or at least some part of it) to another entity(s), CEHR verifies whether the patient(s) who's EHR account(s) is associated with the information (and/or optionally, the appropriate administrator(s) of the CEHR), authorized such transmission of information (or any part of it). If no authorization exists or it is not valid, CEHR does not transmit information or transmits only a part of the information that was authorized for transmission. In another embodiment, a patient may configure such authorization parameters in his or her EHR account using, for example, a software application to access the EHR account (as described earlier). In another embodiment, the CEHR would transmit at least some part of the health-related and/or none health-related information to at least one entity that does not have a CEHR account; providing, however, that such transmission was duly authorized by the patient(s) (and/or optionally by the appropriate administrator(s) of the CEHR). In another embodiment, CEHR may generate its own health-related and/or none health-related information, such as information based on certain data analyses, or CEHR may generate at least one alert and associate the alert with at least one EHR account, and if necessary, transmit the alert information to at least one entity and/or at least one patient and/or a CEHR administrator.

In another embodiment, the information may be transmitted based on schedule, upon a change in an EHR account, or a lack of such change, or some other condition, event, or a set of events/conditions. In another embodiment, such transmission may be contingent upon authorization validity time-period or a limit of the number of times the information can be transmitted, or upon a certain financial-related transaction or some other transaction. In another embodiment, such transmission authorization may be granted to an entity that does not have a CEHR account, or a group of such entities, or a plurality of electronic systems. And in another embodiment, such authorization may allow transmitting only some part of the patient's health-related and/or not health-related information, such as diagnoses or immunization data. The CEHR then only transmits information that is within the scope of authorization.

In one embodiment, for example a doctor that transfers his or her practice from one electronic medical records system to another electronic medical records system may request a copy of all (or some) medical records of his or her patients available in the network-accessible storage repository, assuming proper authorizations of patients exist, to be transmitted to the doctor's new electronic medical records system, thus simplifying medical records migration.

In one embodiment of the proposed invention, CEHR may consist of a plurality of network-accessible storage repositories. In another embodiment, such repositories may be federated using a plurality of registries that provide federation and directory services. For instance, at least some identification information of a plurality of patients and/or entities, having EHR/CEHR accounts, is stored in at least one computer-implemented network-accessible registry (database). In one embodiment, when the CEHR receives a request to transact that requires, for example, locating an EHR account, the request is routed to at least one of the registries. The registry then locates appropriate data in its database, for example, the data referencing location of an EHR account (e.g., meta-data containing URL of specific network-accessible storage repository, etc.), and, for example, redirects the request to the appropriate network-accessible storage repository. In another embodiment, multiple registers can be further federated and appropriate load balancing systems can be implemented to accommodate very large CEHR deployments.

In another embodiment, the CEHR may consist of a plurality of communicatively coupled network-accessible storage repositories configured to synchronize CEHR/EHR accounts (and possibly the associated information), between a plurality of communicatively coupled network-accessible storage repositories. In another embodiment, such synchronization can be performed in near-real-time or upon a certain condition or event.

It is also possible that CEHRs may be deployed in different countries, operating under different laws and regulated or controlled by different organizations. Therefore, it is also possible that a patient or an entity having a CEHR account may have multiple CEHR accounts in multiple CEHRs. Therefore, in one embodiment, multiple CEHRs can be federated using cross-CEHR registries to allow locating and mapping or aggregating information of plurality of patients and/or entities having CEHR accounts in multiple CEHRs.

In another embodiment, the CEHR may include an application development and/or execution environment (application platform) that is operably or communicatively coupled with at least one network-accessible storage repository. Such platform allows rapid development of software applications (programs of instructions) that may communicate with the CEHR. In one embodiment, the application platform includes a user interface that provides tools and utilities for developing applications, whether web-applications, client applications, or other applications. In another embodiment, the application platform provides an execution environment for executing applications on a computing infrastructure, whether local, remote, hybrid, or other kind of computer infrastructure deployment. In another embodiment, the application platform includes at least one application store. In another embodiment, the application platform includes at least one interface where application developers may publish application programming interfaces. In another embodiment, the application platform includes a developer sand-box environment.

Of course, many exemplary variations may be practiced with regard to the proposed invention. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. A computer-implemented method for electronic storing, aggregating and messaging of health-related information comprising of the following:
providing a network-accessible storage repository configured to store at least some electronic health-related information regarding a plurality of patients; each of the plurality of patients having an EHR account that identifies, which electronic health-related information in the network-accessible storage repository is associated with the patient; and
providing that at least one patient can locate and access over a network at least some portion of the electronic health-related and/or none health-related information stored in the network-accessible storage repository, associated with at least one EHR account, and can deposit electronic health-related and/or none health-related information into the network-accessible storage repository, and associate this information with at least one EHR account; and
providing that such network-accessible storage repository is accessible over a network by a plurality of entities, and at least one entity may locate at least one EHR account in the network-accessible storage repository, and may deposit electronic health-related and/or none health-related information to the network-accessible storage repository, and associate this information with an EHR account; further
the network-accessible storage repository saves a copy of the electronic health-related and/or none health-related information and associates this information with an EHR account; and
verifies if at least some part of the said electronic information is authorized by the patient with who's EHR account this information is associated with, to be transmitted over a network to at least one of a plurality of entities; and
if such authorization(s) exists and valid, transmits over a network to at least one of a plurality of electronic systems, accessible by at least one such entity, the authorized part of the said electronic information; and
creates and stores a record about such transaction, containing at least the time of transaction.

2. The method of claim 1, wherein network-accessible storage repository automatically associates electronic health-related and/or none health-related information with at least one EHR account.

3. The method of claim 1, wherein a patient or an entity on patient's behalf creates a new EHR account in the network-accessible storage repository.

4. The method of claim 1, further comprising that network-accessible storage repository provides at least one patient and/or entity with access credentials.

5. The method of claim 1, wherein at least one patient (“patient one”) may authorize at least one other patient (“patient two”) to access at least some electronic health-related and/or none health-related information associated with the “patient's one” EHR account and/or make at least one modification to the “patient's one” EHR account.

6. The method of claim 1, wherein at least one patient or entity deposits electronic health-related and/or none health-related information to the network-accessible storage repository using at least one program of instructions that has a user interface.

7. The method of claim 1, wherein the electronic health-related and/or none health-related information is transmitted to and/or from the network-accessible storage repository using at least one of: HL7, Direct Clinical Messaging, X12, SOAP, MLLP, RPC, and TCP, UDP.

8. The method of claim 1, wherein the electronic health-related and/or none health-related information does not contain identifying indicia of at least one patient and/or at least one entity.

9. The method of claim 1, wherein the electronic health-related information transmitted to at least one entity, includes the entire electronic health-related information associated with at least one EHR account.

10. The method of claim 1, wherein the electronic health-related and/or none health-related information transmitted to at least one entity, includes the electronic health-related and/or none health-related information generated by at least one network-accessible storage repository and associated with at least one EHR account.

11. The method of claim 1, wherein the electronic health-related and/or none health-related information transmitted over a network to at least one entity, includes at least some part of the electronic health-related and/or none health-related information deposited to at least one network-accessible storage repository by more than one entity.

12. The method of claim 1, wherein the electronic health-related and/or none health-related information deposited by a patient or an entity may be associated with at least one entity, instead of, or in consort with an EHR account.

13. The method of claim 1, wherein the electronic health-related and/or none health-related information transmitted to an entity includes electronic health-related and/or none health-related information deposited by at least one patient.

14. The method of claim 1, wherein there is a plurality of federated and/or communicatively coupled network-accessible storage repositories.

15. A system for electronic storing, aggregation and messaging of health-related information comprising of the following:
a network-accessible storage repository that stores at least some electronic health-related information of a plurality of patients, and where each of the plurality of patients having an EHR account that identifies which electronic health-related and/or none health-related information in the network-accessible storage repository is associated with the patient, and such network-accessible storage repository includes:
at least one computing device with operably or communicatively coupled computer-readable storage medium, and
at least one network communications interface, and
computer-readable instructions or program of instructions, which:
a) is capable of associating electronic information with an EHR account, and
b) is capable of automatically storing at least some electronic health-related information on the computer-readable storage medium, and
c) is capable of automatically verifying the existence and validity of at least one patient's authorization to transmit at least some electronic health-related and/or none health-related information associated with at least one patient's EHR account, to at least one entity, and
d) if such authorization exists and valid, transmitting over a network at least some authorized electronic health-related and/or none health-related information to at least one electronic system capable of receiving at least some health-related information, and being accessible by at least one such entity, and
e) is capable of automatically recording at least the time of such transaction on a computer-readable storage medium; further,
the system includes at least one program of instructions that is not operably coupled with the network-accessible storage repository, and that has at least one network communications interface, and at least one user interface, which allows a patient and/or an entity to input electronic health-related information, and where such program of instructions is capable of securely transmitting this information over a network to at least one network-accessible storage repository; in addition,
the system includes at least one electronic system not operably coupled with the network-accessible storage repository, and capable of receiving over a network at least some electronic health-related information from at least one network-accessible storage repository; and
where the network-accessible storage repository executes at least the steps of the process of receiving at least some electronic health-related information from at least one program of instructions that is not operably coupled with the network-accessible storage repository, and associating this information with an EHR account; and
there are computer-readable instructions or at least one program of instructions operably or communicably coupled with the network-accessible storage repository that executes at least the steps of the process of writing at least some electronic health-related information on a computer-readable storage medium; and
there are computer-readable instructions or at least one program of instructions operably or communicably coupled with the network-accessible storage repository that executes at least the steps of the process of verifying the existence and validity of patient's authorization to transmit at least some electronic health-related and/or none health-related information associated with the patient's EHR account to at least one of a plurality of entities; and
there are computer-readable instructions or at least one program of instructions operably or communicably coupled with the network-accessible storage repository that executes at least the steps of the process of transmitting over a network at least some electronic health-related and/or none health-related information associated with an EHR account to at least one of a plurality of electronic systems accessible by at least one entity.

16. The system of claim 15, wherein the electronic health-related and/or none health-related information transmitted from a network-accessible storage repository to at least one of plurality of entities is transmitted using at least one of the following protocols/systems: HL7, Direct Clinical Messaging, X12, SOAP, MLLP, RPC, and TCP, UDP.

17. The system of claim 15, wherein the program of instructions that is not operably coupled with the network-accessible storage repository and that has at least one network communications interface, does not have a user interface, which allows a patient and/or an entity to input electronic health-related information, but instead, it provides an application programming interface.

18. The system of claim 15, wherein such network-accessible storage repository includes computer-readable instructions or at least one program of instructions that is capable of associating electronic health-related and/or none health-related information with at least one entity.

19. The system of claim 15, wherein a plurality of network-accessible storage repositories are federated using at least one registry that provides directory services allowing to discover at least one resource that may be located on at least one of the plurality of network-accessible storage repositories.

20. The system of claim 15, wherein at least one network-accessible storage repository is configured to synchronize at least some information with at least one other network-accessible storage repository.

21. A system for electronic storing, aggregation and messaging of health-related information comprising of the following:
a network-accessible storage repository that stores at least some electronic health-related information of a plurality of patients, and where each of the plurality of patients having an EHR account that identifies which electronic health-related and/or none health-related information in the network-accessible storage repository is associated with the patient, and such network-accessible storage repository includes:
at least one computing device with operably or communicatively coupled computer-readable storage medium, and
at least one network communications interface, and
application programming interface, and
computer-readable instructions or program of instructions, which:
a) is capable of associating electronic information with an EHR account, and
b) is capable of automatically storing at least some electronic health-related information on the computer-readable storage medium, and
c) is capable of automatically verifying the existence and validity of at least one patient's authorization to transmit at least some electronic health-related and/or none health-related information associated with at least one patient's EHR account, to at least one entity, and
d) if such authorization exists and valid, transmitting over a network at least some authorized electronic health-related and/or none health-related information to at least one electronic system capable of receiving at least some health-related information, and being accessible by at least one such entity; further,
the system includes at least one program of instructions that is not operably coupled with the network-accessible storage repository, and that has at least one network communications interface, and at least one user interface, which allows a patient and/or an entity to input electronic health-related information, and where such program of instructions is capable of securely transmitting this information over a network to at least one network-accessible storage repository; in addition,
the system includes at least one electronic system not operably coupled with the network-accessible storage repository, and capable of receiving over a network at least some electronic health-related information from at least one network-accessible storage repository; and
the system includes a software development and/or execution environment that is operably or communicatively coupled with at least one network-accessible storage repository, and that is used to create and/or execute a plurality of programs of instructions that are capable of communicating with at least one network-accessible storage repository.
